(19) United States
(12) Patent Application Publication
(10) Pub. No.: US 2005/0022668 A1
(43) Pub. Date: Feb. 3, 2005

(54) Method and apparatus for removing sulfur components

(76) Inventor: James Anthony Cairns, Dundee (GB)

Correspondence Address: MYERS BIGEL SIBLEY & SAJOVEC, PO BOX 37428, RALEIGH, NC, 27627, US

(21) Appl. No.: 10/647,746

(22) Filed: Aug. 25, 2003

Related U.S. Application Data
(63) Continuation-in-part of application No. 09/856,968, filed on Jun. 21, 2001, now Pat. No. 6,626,983.

(30) Foreign Application Priority Data
Nov. 25, 1998 (GB) GB9825812.2

(51) Int. Cl. B01D 47/02

(52) U.S. Cl. 95/226

(57) ABSTRACT

In the fields of environmental and industrial pollution control there is a need for improvements in the removal of fine particulates, especially of sizes in the sub-micron ranges, from gas streams. The disclosure relates to an apparatus including a container for a liquid submerged in which in some embodiments, is a pipe transporting a particulate-containing gas. The pipe permits passage of the gas through the liquid before it exhausts from the container. The liquid is such as to wet the particulates, thereby retaining them in the liquid while the gas passes through the liquid to the exhaust.

### CROSS-REFERENCE TO RELATED APPLICATIONS

This application is a continuation-in-part of U.S. patent application Ser. No. 09/856,968; filed Jun. 21, 2001, now allowed, which is a U.S. national phase of international application No. PCT/GB99/03930, having an international filing date of Nov. 25, 1999, which claims priority to Great Britain Application No. 9825812.2, filed Nov. 25, 1998, the disclosures of which are hereby incorporated herein by reference in their entirety.

### FIELD OF THE INVENTION

This invention relates to a method and apparatus for removing oxides of sulfur or oxides of sulfur and particulates and/or other undesirable components from an exhaust gas stream. The invention also concerns a method of producing sulfuric acid from the removed oxides of sulfur.

### BACKGROUND OF THE INVENTION

There are many instances when it is desirable to remove oxides of sulfur from a gas stream which may also contain particulates and/or other undesirable components. For example in many industrial processes it is desirable for gases to be cleaned of sulfur components before undergoing e.g. chemical or physical processing, such as catalytic processing so that the catalyst is not poisoned by the sulfur components.

Another field in which sulfur oxides removal is desirable is that of diesel engine exhausts.

Diesel engines are widely used throughout the world, particularly in heavy vehicles (trucks, buses and trains) and increasingly in automobiles. They are also used in large ocean going ships and other water borne vessels. Diesel engines are robust, fuel-efficient, long-lasting, and emit relatively low levels of carbon monoxides but they suffer from two major disadvantages which are causing increasing environmental concern. These are: (a) the emission of particulates, and (b) the emission of undesirable components such as oxides of nitrogen, and/or polynuclear hydrocarbons.

The particulates, which are carbonaceous in nature, are associated with undesirable hydrocarbons, of which the class known as polycyclic aromatic hydrocarbons are of particular concern. One of these compounds, 3-nitrobenzxanthrone, has been reported (Suzuki et al, Environment Science and Technology, Volume 3, page 2772, 1997) as being extremely active in causing mutations in the DNA of standard strains of bacteria, as measured by the so-called Ames Test. Other compounds also present in diesel exhaust gases, such as 1,8-dinitropyrene, have also been found to be strongly mutagenic. These observations point to a strong link between diesel exhaust emissions and carcinogens in the atmosphere. It has been estimated that the tiny combustion particles, especially those with dimensions of less that 1 micrometre, are capable of carrying these chemicals into the deep recesses of human lungs. Virtually all diesel particles are in this size range (Michael P. Walsh “Global Trends in Diesel Emission Control—1 1997 Update”, SAE Technical Series Paper 970179). Particulates from diesel exhaust gases may cause 10,000 deaths in Britain and 60,000 deaths in the USA each year. (“Dying from too much dust”, New Scientist, 12 Mar. 1994, page 12). This leads to the conclusion of J. Merefield and I. Stone (New Scientist, 20 Sep. 1997), page 58) that “we could greatly improve our health and the urban air if we had better control over our vehicles' exhausts”.

Oxides of nitrogen (and ozone) are also very undesirable atmospheric pollutants because they generate oxygen radicals, which can damage DNA and attack cell membranes. Nitrogen dioxide, NO₂, emitted from diesel engines is capable of producing oxygen atoms under the influence of sunlight, i.e.:
sunlight+NO₂→NO+O.

These oxygen atoms can then combine with oxygen in the atmosphere to form ozone, O₃, i.e.:
O+O₂→O₃.

This explains why ozone pollution is especially serious during warm, sunny days. It should be noted also that ozone is harmful not only to humans in a number of ways (damage to airways linings, inflammatory reactions, and increased likelihood of asthma attacks), but also to vegetation, causing reduced yields from a range of crops including wheat, barley and peas.

Oxides of sulfur are also a very undesirable atmospheric pollutant because they cause acid rain which can poison tree plantations, damage buildings and pollute water courses. A recent report indicates that smoke from ships is becoming the biggest source of acid rain-causing pollution. It is estimated that ships sailing through European waters produce 1.9 million tonnes of sulfur dioxide per year. There is thus a need to remove sulfur dioxide (SO₂) from marine combustion systems.

Naturally, because of the worldwide concerns for these problems, there has been a great deal of effort directed towards finding a solution. The most obvious of these, designed to remove particulates, makes use of filters or traps. The main problem with these is that they tend to become blocked, which results in numerous inefficiencies in the operation of the engines to which they are attached. This technology has been studied extensively. (See, for example, Y. Teraoka et al., Catal. Today, Volume 27, page 107 (1996). It is possible to regenerate the filters by burning off the trapped soot, and this procedure is rendered more efficient if a catalyst is incorporated into the filter material (as referred to by J. P. A. Neeft et al., in Appl. Catal. B. Environmental, Volume 8, Page 57 (1996)). Naturally this constant need for removal and regeneration is a serious disadvantage. An alternative approach has been advocated by Cooper and Thoss (SAE Technical Paper 890404 (1989)). In this case a platinum-containing catalyst was mounted upstream of a particulate trap in order to oxidise nitrogen to nitrogen dioxide. The resulting NO₂ is a powerful oxidising agent which is capable of removing carbon, viz.,
2NO₂+C→3NO+CO₂.

Unfortunately, as this equation shows, the reaction generates nitric oxide. Furthermore, the catalyst is sensitive to poisoning by sulfur, which is present to a greater or lesser extent in diesel fuels throughout the world.

Therefore it is clear that there is a need for a system which is capable of removing the sulfur components from a gas stream and optionally particulates efficiently (especially those smaller than 1 μm).

U.S. Pat. No. 5,453,107 and U.S. Pat. No. 3,803,813 disclose apparatus for filtering particulates from exhaust and other gases wherein the gas is first bubbled through a liquid prior to passing through a filter.

U.S. Pat. No. 5,129,926 describes an engine exhaust system comprising a water-filled scrubber tank through which the exhaust gas is released. The system further comprises a moisture trap for returning some of the condensed gas back to the inlet manifold of the engine and a filter to filter the gases once they are passed through the moisture trap.

U.S. Pat. No. 3,957,467 discloses an exhaust gas purifier and silencer in which exhaust gases are first released from a conduit into a liquid to purify the gas and thereafter returned to the same conduit and exhausted.

### DETAILED DESCRIPTION OF THE INVENTION

According to a first aspect of the invention, there is provided a method of removing oxides of sulfur from an exhaust gas stream, comprising wetting at least a portion of the exhaust gas stream in order that the oxides of sulfur are entrapped and/or dissolved in the liquid thereby cleaning the exhaust gas; and further comprising cooling the exhaust gas stream and/or cleaned exhaust gas to condense desired fractions thereof.

This method is advantageously simple, and inexpensive. Also, the method of the invention has the capability of removing certain oxides of nitrogen and particulates.

Desirably, the majority or substantially all the gas stream is wetted.

It is to be understood that the term wetting includes both passing said at least a portion of the gas stream through a liquid, or merely blowing the gas stream onto the liquid in order to wet it.

Preferably the liquid is or is predominantly water, and more preferably includes a detergent. In preferred embodiments the detergent constitutes 1 part in 50,000 of the liquid.

The detergent ensures that the liquid wets fine particulates, and has been found to be particularly effective when the gas stream is diesel exhaust gas.

However, nitric oxide is only sparingly soluble in water, thus a strong oxidising agent such as ozone may be provided in order to oxidise nitric oxide to nitrogen dioxide.

Additionally, or alternatively the water may contain sodium carbonate in order to convert any sulfur present in the gas stream to sodium sulphate. The liquid may include antifreeze (e.g. ethylene glycol). This makes the method of the invention more suitable for use in road vehicles used in cold climates.

In one arrangement the step of wetting the gas stream occurs in a container having a splash guard for minimising fragmentation and/or loss of the liquid from the container.

The splash guard advantageously prevents the liquid from being thrown outwardly of the container under the force of the gas stream.

Conveniently the step of wetting the gas occurs in a vessel having an outlet for cleaned gas, the method including the step of cooling the cleaned gas to condense desired fractions thereof. This step ensures that any of the liquid vaporised and conveyed to the outlet with the cleaned gas is condensed and thereby available for further use in the method of the invention. This feature is particularly advantageous when the method is used to clean diesel exhaust gases, that are usually at a high enough temperature when passed through the liquid to vaporise the latter. The condensing step avoids wastage of the liquid.

Typically the cooling takes place in the cleaned gas outlet. If the cleaned gas outlet is appropriately located, the condensed liquid may flow under gravity back to the main body of liquid in the container.

The splash guard (when present) also optionally cools the cleaned gas. This may be achieved e.g. by manufacturing the splash guard from a material having a comparatively high thermal conductivity. Many metals are suitable.

Preferably the gas stream flows into the liquid via a submerged pipe having a plurality of apertures defining an aggregate area at least equal to the diameter of the pipe. This feature ensures that the method does not cause serious back-pressure.

Alternatively the gas stream may be blown onto the surface of the liquid via a pipe. The pipe may be positioned in the container so as to induce mixing or swirling of the liquid on blowing of the gas stream onto the surface of the liquid. This can serve to ensure adequate wetting of the gas stream.

In turn this means that the method is useable to clean the exhausts of internal is combustion engines, since the method can be practised without significantly affecting the engine exhaust back-pressure.

Preferably the gas stream is or includes exhaust gas from an internal combustion engine, particularly a compression ignition engine.

The method may optionally include filtering of the liquid. This may allow a quantity of the liquid to be used several times. The invention may include the step of further passing a gas stream through the filtered liquid.

According to a second aspect of the invention, there is provided an apparatus for removing oxides of sulfur from a gas stream and forming sulfuric acid, comprising a container containing a first liquid; an inlet for the gas stream permitting wetting of at least a portion of the gas stream; and a first outlet from the container for cleaned gas wherein the inlet and/or first outlet includes condensing means for cooling desired fractions of the gas steam, and/or cleaned gas; a second outlet coupled to filter means for removing particulates from the first liquid; heating means to evolve the oxides of sulfur from the first liquid; condenser means to remove water vapour from the evolved oxides of sulfur; reacting means for converting the oxides of sulfur into a form for sulfuric acid formation; and absorbing means for dissolving the converted oxides of sulfur into a second liquid.

This apparatus advantageously permits practising of the methods of the invention.

The conversion of the oxides of sulfur may be an exothermic reaction and therefore, the apparatus may optionally include heat exchanger means for cooling the conversion reaction.

Conveniently the inlet for the gas stream includes a pipe, connected to a source of the gas stream, at least partially submerged in the liquid and including one or more apertures or perforations permitting passage of the gas stream through the liquid. Preferably the aggregate surface area defined by the apertures in the pipe generally equals the transverse cross-sectional area of the pipe. These features ensure that the apparatus of the invention does not adversely influence the pressure of the gas stream being supplied to it.

Alternatively the inlet for the gas stream includes a pipe, connected to a source of the gas stream, arranged so as to enable the gas stream to be blown onto the surface of the liquid.

Typically the first liquid is or is predominantly water, particularly water and a detergent approximately in the ratio 1 part detergent to 50,000 parts water. The liquid may also include an antifreeze. The key features of the liquid are that it adequately wets the particulates; and that it does not react undesirably with the gas. Thus any of a range of liquids may be suitable. For example the liquid may include an oxidising agent and/or a carbonate, such as sodium carbonate in order to assist with the removal of undesirable components such as nitric oxide and/or oxides of sulfur from the gas steam. A suitable oxidising agent is ozone. Thus, in a preferred embodiment the apparatus of the invention further comprises an ozone generator for providing ozone to the container. Preferably at least a portion of the ozone is passed into the liquid.

The second liquid may be or substantially comprise water. However, oxides of sulfur e.g. sulfur dioxide can react with water in an exothermic reaction resulting in heat generation.

Desirably the second liquid is sulfuric acid which absorbs sulfur trioxide to form oleum (H₂S₂O₇), which can then be diluted with water to give sulfuric acid.

In some instances it may not be desirable to include antifreeze in the first and/or second liquid, for example, to minimise cost. In such circumstances it is desirable for the pipe to comprise further perforations which extend above the surface of the liquid. Thus, should the liquid freeze, the gas can still escape from the pipe by way of the perforations above the frozen liquid surface. Once the liquid defrosts, the majority of the gas stream will pass through the liquid.

These features assist in practising of the method of the invention.

Conveniently the apparatus includes a splash guard for minimising fragmentation and/or loss of the liquid from the container. The function of this is described above.

In preferred embodiments the splash guard includes a perforated plate, especially one having plural perforations, covering or substantially covering the surface of the liquid. Conveniently the splash guard includes a wire mesh overlying the surface of the liquid. In practical embodiments the wire mesh overlies, and covers, the perforated plate.

This design of splash guard has been found to be particularly effective in limiting fragmentation (splashing) of a foaming liquid such as water and detergent mix. If the splash guard (or part thereof) is manufactured from a material, such as a metal, having good thermal conductivity, the splash guard advantageously serves to cool any liquid splashing onto it and any gas passing through it. This tends to condense any of the liquid vaporised by heat in the gas stream. The condensed liquid falls into the main body of liquid via the perforations, and is thus made available for re-use.

Conveniently the outlet for cleaned gas includes a pipe containing a wire mesh. The wire mesh in the pipe also serves to cool and condense vaporised liquid. If the location of the pipe is correctly chosen the thus condensed liquid flows back to the main body thereof and is available for re-use.

Conveniently the apparatus includes a cooler for the outlet for cleaned gas. Preferably the cooler is or includes one or more cooling pipes surrounding or within the outlet and having flowing therein a cold fluid. The cooler assists in the condensation of the cleaned gas which may comprise vaporised liquid and thus helps to minimise evaporation of the liquid from the container.

The apparatus optionally includes for filtering of particulates from the liquid. Conveniently the container includes one or more apertures for filling it with and emptying it of the liquid, thereby permitting use of the filter remotely of the container and return of the filtered liquid to the container. These features allow the liquid to be re-used several times.

In a preferred embodiment the apparatus includes a particulate detecting device, operatively connected to monitoring apparatus, in the outlet for cleaned gas. This feature permits monitoring of the cleaned gas output, and if necessary can be used to indicate when filtering of the liquid is needed.

According to a third aspect of the present invention there is provided a method of producing sulphuric acid comprising:

Removing oxides of sulfur from an exhaust gas stream by entrapping and/or dissolving the oxides of sulfur in a liquid;
evolving the oxides of sulfur from the liquid and converting the evolved oxides of sulfur into a form for sulphuric acid formation;
   dissolving the converted oxides of sulfur into water to form sulfuric acid, or dissolving the converted oxides of sulfur into sulphuric acid to form oleum and subsequently diluting the oleum with water to form sulphuric acid.

In the method, typically the converted oxides of sulfur comprise substantially sulfur trioxide.

Desirably, in the method, the converting step is achieved with a vanadium pentoxide catalyst.

According to a fourth aspect of the present invention, there is provided a vessel craft designed for water transport including the above-described apparatus according to the second aspect of the present invention. Preferably, the vessel craft is a ship. Suitable examples of ships are ocean-going liners, oil tankers, cargo ships and the like.

The dependent claims hereof set out further, optional features of the invention.

There now follows a description of preferred embodiments of the invention, by way of example, with reference being made to the accompanying drawings in which:

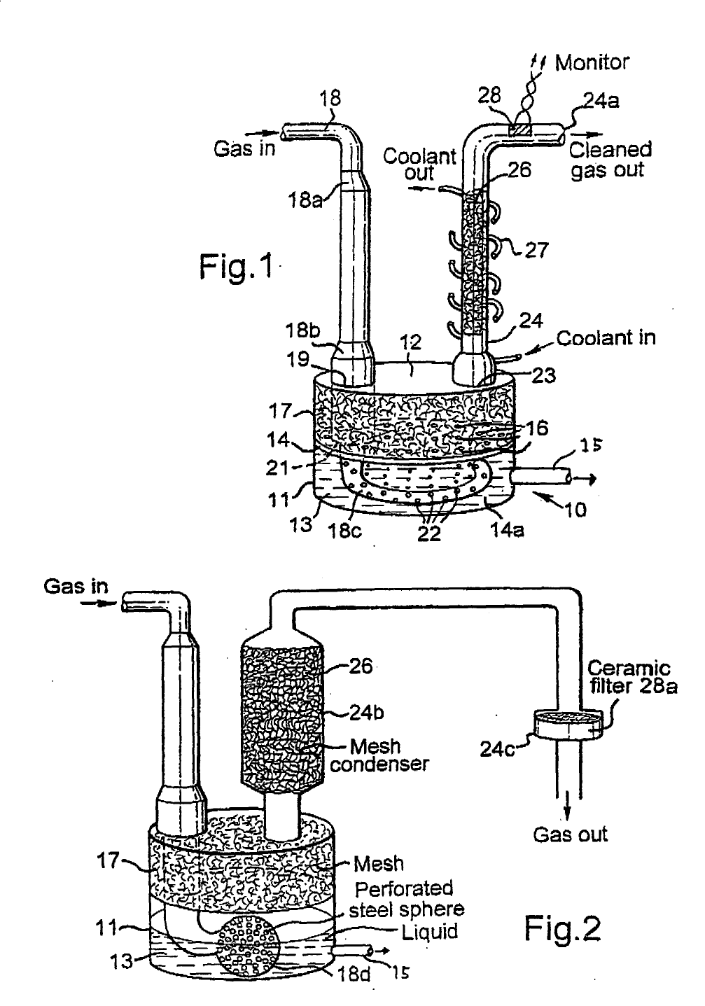

FIG. 1 is a schematic view of a first embodiment of apparatus and a method according to the invention;

FIG. 2 is a schematic view of a second embodiment of apparatus according to the invention;

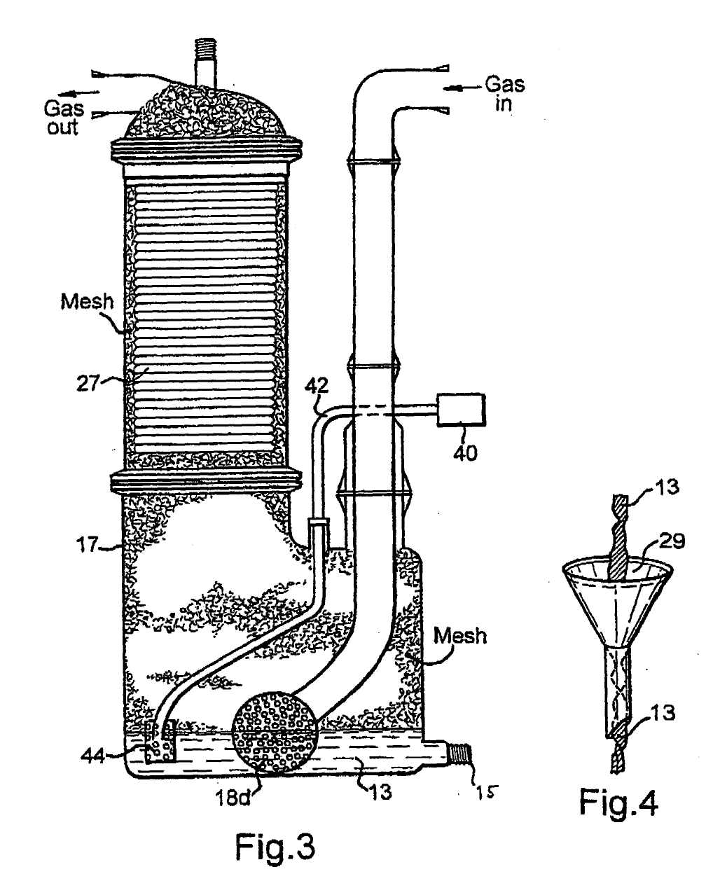

FIG. 3 is a schematic view of a third embodiment of apparatus according to the invention;

FIG. 4 shows filtering of liquid after use of the apparatus of FIGS. 1, 2 or 3;

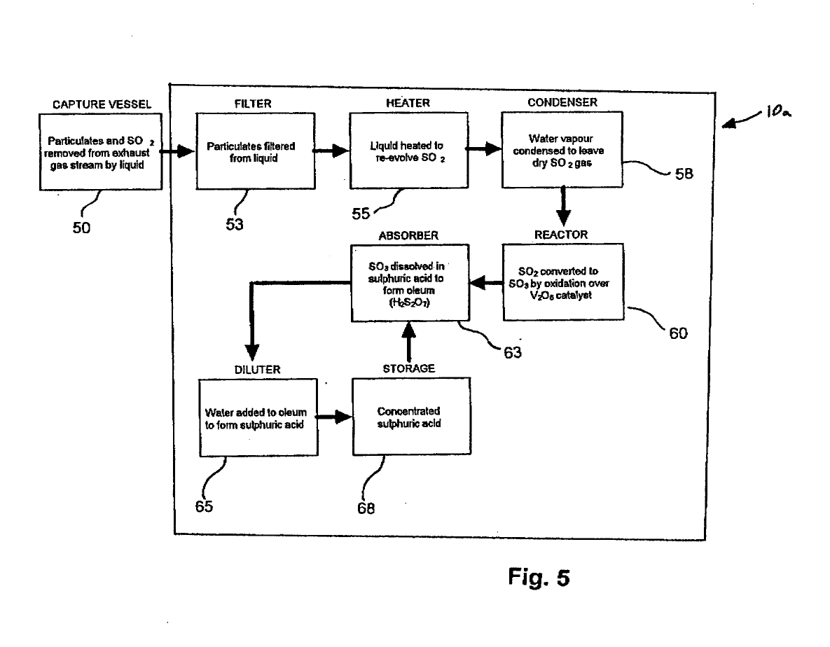

FIG. 5 is a schematic flow diagram of processing steps for sulfuric acid production.

FIG. 1 shows an apparatus 10 according to the invention comprising a generally cylindrical container 11 having an open upper end that is sealingly closed by a lid 12.

Container 11 contains a liquid 13 that is, essentially, a 1:50,000 (or other ratio) mix of a liquid detergent (i.e. ARIEL FUTUR® (manufactured by Procter & Gamble)) and water in the embodiment shown. Other detergents may of course be used, in which case the ratio of detergent to water may require adjustment. It is essential only that the liquid 13 is capable of wetting the fine particulates (e.g. those of a diameter less than 0.1 μm) described herein. The detergent/water mixture has been found to be highly successful in this regard.

Liquid 13 may also contain an antifreeze, thereby permitting use of the apparatus over a wide range of ambient temperatures, including sub-zero temperatures.

The liquid 13 resides in approximately the lower half of container 11. A circular plate 14, of approximately the same diameter as container 111 and having formed therein a plurality of generally regularly spaced apertures 16 overlies the liquid 13.

Plate 14 may be supported by brackets or an equivalent support (not visible in FIG. 1) that secure it within container 11.

Typically the plate 14 is formed from a metal such as stainless steel (or alloys including such metals). This confers on the plate 14 the thermal conductivity discussed herein.

Overlying plate 14 is a layer 17 of woven, knitted or otherwise mingled wire strands defining a mesh. Preferably the wire strands are of stainless steel or aluminium containing ferritic steel; or other materials (including non-metals) capable of withstanding conditions within container 1.

An inlet pipe 18 for a sulfur and optionally particulate-containing gas stream is connected to e.g. the exhaust manifold of a diesel engine, or an item of process plant, whereby a stream of the sulfur containing gas (signified by “Gas In” in FIG. 1) may be fed to the interior of container 11.

In the embodiment shown, pipe 18 optionally enlarges in diameter in two locations, visible at 18a and 18b, near lid 12.

This is because the embodiment of FIG. 1 is intended for attachment to the exhaust outlet of a diesel engine. It is important that the apparatus 10 does not induce undesirable back-pressures into the exhaust tract of the engine.

Pipe 18 passes downwardly, via an aperture 19, through lid 12. Pipe 18 is a sealing fit in aperture 19.

From aperture 19, pipe 18 passes downwardly through a substantially cylindrical space in layer 17 and through a further aperture 21 to seal about pipe 18.

Below plate 14 pipe 18 is reduced diameter (signified by numeral 18c) and terminates in a curved portion located on or adjacent to the base 14a of container 11. The curvature of portion 18c generally follows that of the wall of container 11.

Portion 18c has formed therein and distributed along its length a plurality of apertures 22 that allow egress of the particulate-containing gas from pipe portion 18c into the liquid 13 in which portion 18c is submerged.

In the embodiment shown, the pipe portion 18c is manufactured from a flexible material although this need not necessarily be so.

On its side opposite aperture 19 lid 12 includes a further, through-going aperture 23 that is sealingly secured about a cleaned gas outlet pipe 24. Outlet pipe 23 terminates above the surface of liquid 13 so that any gas under pressure in the upper half of container 11 passes into outlet pipe 24.

A length of pipe 24 is partially filled with a further quantity 26 of mingled, preferably stainless steel, wire strands in a mesh. Mesh 26 may also be of any other material (including non-metals), in a similar way to mesh 17. Preferably the meshes 17 and 26 are irregular.

An optional feature of the apparatus 10 is a coil or other arrangement of cooling pipes 27 that may encircle, be embedded in the walls of or may lie within pipe 24 for the purpose of cooling the mesh 26 and any gas in pipe 24. This is achieved by circulating a coolant such as water (preferably cold water) in the pipe(s) 27, e.g. by means of a per se known coolant pump circuit of which the pipe(s) 27 form a part. If desired the temperature in pipe 24 may be controlled by e.g. a feedback-type control for the coolant pump.

Cleaned, cooled gas (indicated in FIG. 1 by “Cleaned gas out”) typically exhausts to atmosphere from the open end 24a of pipe 24. However, if the apparatus 10 is used for cleaning gases for use in process equipment, pipe 24 may of course be connected to other apparatuses as necessary.

Optionally pipe 24 may include therein, downstream of mesh 26, a device 28 capable of detecting fine particulates in the gas emerging via the pipe 24. The device may be connected to an apparatus (e.g. containing a microprocessor), for monitoring the cleanliness of the gas in pipe 24. Such optional features of the invention may be used e.g. to warn users of the need to filter the liquid 13 when it reaches its particulate-bearing limit, or replace with fresh liquid.

The container 11 may as shown be formed partly or wholly of a transparent or translucent material such as glass or some polymeric materials. This allows visual inspection of the condition of the liquid, which tends to darken as more and more particulates become entrained in it.

Container 11 includes an outlet 15 through which liquid 13 can be drawn for further processing in apparatus 10a which is shown schematically in FIG. 5. Apparatus Oa may be separate from or integral with the apparatus 10.

FIG. 2 shows a second embodiment of the invention including several optional modifications. The optional modifications may be employed alone, or in combination with one another. The mesh 17 may be supported above the liquid in the FIG. 2 embodiment.

In the FIG. 2 embodiment the perforated portion 18d of pipe 18 is spheroidal in shape, with the perforations spaced all around the sphere. This maximises contact of the gas with the liquid.

As shown in FIG. 2, the spheroidal portion 18d does not have to be completely submerged in the liquid 13. This permits a gas flow even if the liquid 13 freezes.

In the FIG. 2 embodiment the cooling pipes 27 optionally are dispensed with. Instead the outlet pipe 24 may include an enlarged diameter portion 24b containing a comparatively large amount of mesh material 26 as aforesaid, that is thermally conductive. This mesh acts to condense the exiting gas stream. This arrangement may obviate the need for a cooling liquid.

Outlet pipe 24 includes a second, enlarged diameter portion 24c that encloses and supports a ceramic filter 28a. The condition (i.e. cleanliness) of the filter may be used to indicate any need for filtering of the liquid 13.

Another optional feature of the invention, not visible in FIGS. 1 and 2, is for the container 11 to be substantially hemispherical. This leads to spiralling of the gas flows in the same direction in the liquid, at a rate of spiralling generally proportional to engine speed.

This phenomenon gives rise to good flow characteristics in the liquid 13. it also permits the generation of a large number of smaller gas bubbles in the liquid, thereby improving mixing of the gas and liquid. Also a hemispherical chamber 11 that is approximately half full of liquid 13 permits displacement of liquid 13, giving rise to good mixing.

The container 11 in the FIG. 2 embodiment may optionally include an outlet for drawing off liquid 13 for further processing.

FIG. 3 shows a third embodiment of the invention including further modifications. The optional modifications may be employed alone, or in combination with one another.

The apparatus shown in FIG. 3 further includes an ozone generator 40 as supplied for example by ozone systems, St. Helens Merseyside England. Typically such an ozone generator may generate at least 1 g/hr of ozone. Ozone generated by the generator 40 passes along pipe 42 and into the liquid 13 through a perforated end piece 44.

There now follows a description of experimental operation of the apparatus 10 (FIG. 1) when connected to the exhaust tract of a diesel engine.

Hot exhaust gas from the engine passes into the liquid 13 via pipe 18 and aperture 22. Pipe portion 18c has a large number of small apertures 22, such that the total area of the apertures 22 is at least equal to the cross-sectional area of the incoming part of pipe 18, thereby minimising back-pressure. The exhaust gas emerges through these apertures 22 in the form of a large number of small jets, thereby ensuring good interaction between the gas and the liquid 13. The splash guard comprising plate 14 and mesh 17 prevents splashing of liquid 13 and causes any vapour components thereof to condense back to liquid. Mesh 26 situated in the outlet pipe 24 performs a similar function.

As previously noted the preferred liquid 13 in the container 11 is water. However, it was initially observed that if pure water is used then particulates begin to accumulate gradually in the outlet tube 24. This effect is prevented by adding a very small concentration of detergent to the water, i.e. typically 1 part detergent in 50,000 parts of water when the detergent is “ARIEL FUTUR” ®.

When it was required for the apparatus 10 to operate efficiently also in sub-zero temperatures, a liquid containing a 1:1 mixture of water and antifreeze was used. This was found to operate satisfactorily.

The efficiency of the apparatus 10 for removing particulates was tested on a single cylinder diesel engine (Lister FR1, 800 cc) mounted on a test bed and coupled to a dynamometer to enable it to be run under varying loads. A filter 28a (FIG. 2) in the form of a ceramic monolith (10 mm dia.×2 mm thickness) containing a multitude of channels was mounted downstream to capture a sample of any particulates. It was found that in the absence of the apparatus 19 it quickly became coated with black particulates, whereas in the presence of the apparatus 10 it remained perfectly clean. It was found also that after running the engine for several hours, by which time the liquid had become black, the liquid could be filtered through a conventional filter paper 29 (FIG. 4) remote from the apparatus 10 which collected the carbonaceous material. The liquid emerging from the filter was quite clear, and could be re-used.

Another advantage of this liquid-based system is its potential for removing oxides of nitrogen and sulfur. Both N₂O and NO₂ are soluble in water. NO, although only slightly soluble, can be oxidised for example by ozone to water-soluble NO₂. Similarly, SO₂ can be removed by dissolving in the water.

This represents an advantage over those catalytic systems which are liable to poisoning by sulfur-containing fuels.

Advantageously, the liquid 13 drawn from the apparatus of FIG. 1, 2 or 3 may be processed to convert the oxides of sulfur dissolved in the liquid 13 into sulfuric acid.

FIG. 5 shows schematically the process steps which are employed in an embodiment of the invention to process liquid 13.

Box 50 represents the container 11 which contains liquid 13 in which is entrapped particulates and dissolved oxides of sulfur such as sulfur dioxide.

The liquid 13 is removed in the first stage of the process and introduced into apparatus 10a where it passes through a filter device which is represented by box 53 to remove the particulates from liquid 13.

Following filtering, the liquid 13 is heated to re-evolve the dissolved sulfur dioxide which is represented by box 55.

A condenser is then used to remove water vapour to give dry sulfur dioxide gas, as represented by box 58, which is then passed to a reactor where the sulfur dioxide is converted to sulfur trioxide by oxidation over a vanadium pentoxide catalyst as represented by box 60.

Following conversion, the sulfur trioxide is absorbed and dissolved in concentrated sulfuric acid to give oleum (H₂S₂O₇) which is represented by box 63. The oleum can then optionally be diluted with water to form concentrated sulfuric acid as represented by box 65, and stored in a storage vessel as indicated by box 68. The concentrated sulfuric acid can then be used to replenish that used for absorption of sulfur trioxide.

By this method, the sulfur dioxide extracted from the exhaust gas is converted to sulfuric acid which is one of the most important manufactured products due to it being used in many industrial processes such as in the manufacture of detergents, plastics and explosives.

The apparatus 10a represented by FIG. 5 when integral with the apparatus of FIG. 1, 2 or 3 is particularly advantageous for incorporation into a ship vessel. The average content of marine heavy fuel oil is 2.9% and assuming that all of this were converted to sulfuric acid it may be calculated that approximately 0.1 tonnes of sulfuric acid would be generated for every tonne of fuel combusted.

It is understood that in the embodiments shown in FIGS. 2 and 3 a portion of the gas stream does not pass into the liquid. Nevertheless, the gas passing out of the apparatus is found to be extremely clean. Without wishing to be bound by any particular theory it is thought that the particulates not passing into the liquid may be initially trapped by the wire mesh. Liquid which evaporates is in turn condensed by the cooling tubing and/or wire mesh. The condensed liquid then serves to wash the wire mesh removing the entrapped particulates. Additionally or alternatively it is thought that due to the blowing action of the gas stream that a film of liquid forms on the inside surface of the sphere which ensures wetting of the portion of the gas not passing through the liquid.

In an embodiment of the present invention where the container is generally cylindrical in shape and a pipe is used to blow the gas stream onto the surface of the liquid it has been advantageously found that the end of the pipe, from which the gas stream is blown, may be directed onto the surface of the liquid towards the inside wall of the container. This induces a mixing or swirling of the liquid which serves to improve the wetting of the gas stream.

Naturally an alternative approach to reducing the sulfur dioxide pollution would be simply to remove the sulfur from the fuel oil prior to combustion. One well established way to do this is to use a hydrodesulfurization process in which a catalyst containing elements such as cobalt and molybdenum is used to convert the sulfur to hydrogen sulfide (H₂S) and then to elemental sulfur, which in turn can be converted, via sulfur dioxide into sulfuric acid. The cost of adopting this approach can be considerable.

Therefore, the method and apparatus as hereinbefore described with reference to the specific embodiments represents a simple procedure to remove and convert sulfur dioxide into a useful product and also one which can remove carbon particulates.

1. A method of removing oxides of sulfur from an exhaust gas stream, comprising wetting at least a portion of the exhaust gas steam in order that the oxides of sulfur are entrapped and/or dissolved in the liquid thereby cleaning the exhaust gas; and further comprising cooling the exhaust gas steam and/or cleaned exhaust gas to condense desired fractions thereof.

2. A method according to claim 1 wherein particulates and/or other undesirable components are removed from the gas stream.

3. A method according to claim 1 wherein the liquid is or is predominantly water.

4. A method according to claim 1 wherein the liquid includes a detergent.

5. A method according to claim 4 wherein the detergent constitutes approximately 1 part in 50,000 of the liquid.

6. A method according to claim 1 wherein the liquid includes antifreeze.

7. A method according to claim 1 wherein the step of passing the gas steam occurs in a container having a splash guard for minimising loss of the liquid from the container.

8. A method according to claim 7 wherein the step of cooling takes place in an outlet for cleaned gas.

9. A method according to claim 7 wherein the splash guard cools the cleaned gas.

10. A method according to claim 1 wherein the gas stream flows into the liquid via a submerged pipe having a plurality of apertures defining an aggregate area at least equal to the diameter of the pipe.

11. A method according to claim 1 wherein the exhaust gas steam is blown onto the surface of the liquid.

12. A method according to claim 1 wherein the exhaust steam is from an internal combustion engine.

13. A method according to claim 12 wherein the exhaust gas is from a compression ignition engine.

14. A method according to claim 13 wherein the compression ignition engine burns a heavy gasoline fraction.

15. A method according to claim 1 comprising the further step of filtering the liquid to remove particulates therefrom.

16. A method according to claim 12 wherein the engine is located in a vessel craft designed for water transport.

17. A method according to claim 15 including the further step of further passing a gas stream through the filtered liquid.

18. An apparatus for removing oxides of sulfur from a gas stream and forming sulfuric acid, comprising a container containing a first liquid; an inlet for the gas stream permitting wetting of at least a portion of the gas stream; and a first outlet from the container for cleaned gas wherein the inlet and/or first outlet includes condensing means for cooling desired fractions of the gas steam, and/or cleaned gas; a second outlet coupled to filter means for removing particulates from the first liquid; heating means to evolve the oxides of sulfur from the first liquid; condenser means to remove water vapour from the evolved oxides of sulfur; reacting means for converting the oxides of sulfur into a form for sulfuric acid formation; and absorbing means for dissolving the converted oxides of sulfur into a second liquid.

19. An apparatus according to claim 18 wherein the first liquid is or is predominantly water.

20. An apparatus according to claim 18 wherein the first liquid includes a detergent.

21. An apparatus according to claim 20 wherein the detergent constitutes approximately 1 part in 50,000 of the first liquid.

22. An apparatus according to claim 18 wherein the first liquid includes an antifreeze.

23. An apparatus according to claim 18 including a splash guard for minimising loss of the liquid from the container.

24. An apparatus according to claim 23 wherein the splash guard includes a perforated plate covering or substantially covering the surface of the liquid.

25. An apparatus according to claim 24 wherein the plate includes plural perforations

26. An apparatus according to claim 18 including a wire mesh overlying the surface of the first liquid.

27. An apparatus according to claim 26 wherein the wire mesh overlies the perforated plate.

28. An apparatus according to claim 18 wherein the outlet for cleaned gas includes a pipe containing a wire mesh.

29. An apparatus according to claims 18 including a cooler for the outlet for cleaned gas.

30. An apparatus according to claim 29 wherein the cooler is or includes one or more cooling pipes surrounding or within the outlet and having flowing therein a cold fluid.

31. An apparatus according to claim 29 wherein the cooler includes a mesh of thermally conducting material in the outlet, for condensing gas in the outlet.

32. An apparatus according to claim 18 wherein the inlet for the gas stream includes a pipe, connected to a source of the gas stream, at least partially submerged in the liquid and including one or more apertures permitting passage of the gas steam through the liquid.

33. An apparatus according to claim 18 wherein the inlet for the gas stream includes a pipe arranged such that the gas stream is blown onto the surface of the liquid.

34. An apparatus according to claim 18 including a filter for filtering of particulates from the liquid.

35. An apparatus according to claim 34 wherein the container includes one or more apertures for filling it with and emptying it of the liquid, thereby permitting use of the filet remotely of the container and return of the filtered liquid to the container.

36. An apparatus according to claim 18 including a particulate detecting device, operatively connected to monitoring apparatus, in the outlet for cleaned gas.

37. An apparatus according to claim 18 including a filter in the outlet for cleaned gas.

38. An apparatus according to claim 37 wherein the filter is a ceramic filter.

39. An apparatus according to claim 18 wherein the container is generally hemispherical or spheroidal.

40. An apparatus according to claim 18 further comprising an ozone generator for providing ozone to the container in order to react with undesirable components of the gas stream to reduce or substantially eliminate said undesirable components from being passed out of the container with the cleaned gas.

41. An apparatus according to claim 18 wherein the reacting means includes a vanadium pentoxide catalyst.

42. An apparatus according to claim 18 wherein the converted oxides of sulfur comprise substantially sulfur trioxide and the second liquid is sulfuric acid.

43. An apparatus according to claim 18 which additionally comprises diluting means for diluting the second liquid.

44. A vessel craft designed for water transport including the apparatus according to claim 18.

45. The vessel craft according to claim 44, wherein the vessel craft is a ship.

46. The ship according to claim 45, wherein the ship is selected from an ocean-going liner, an oil tanker or a cargo ship.

47. A method of producing sulfuric acid comprising:
removing oxides of sulfur from an exhaust gas stream by entrapping and/or dissolving the oxides of sulfur in a liquid;
evolving the oxides of sulfur from the liquid and converting the evolved oxides of sulfur into a form for sulfuric acid formation;
dissolving the converted oxides of sulfur into sulfuric acid to form oleum and subsequently diluting the oleum with water to form sulfuric acid.

48. A method according to claim 47 wherein the converted oxides of sulfur comprise substantially sulfur trioxide.

49. A method according to claim 47 wherein the converting step is achieved with a vanadium pentoxide catalyst.
